(19) United States
(12) Patent Application Publication
(10) Pub. No.: US 2011/0227325 A1
(43) Pub. Date: Sep. 22, 2011

(54) All - Day Sports Playbook

(76) Inventor: Dina M. DeGree, Henderson, NV (US)

(21) Appl. No.: 12/799,093

(22) Filed: Apr. 16, 2010

Related U.S. Application Data
(60) Provisional application No. 61/340,406, filed on Mar. 17, 2010.

(51) Int. Cl. B42D 5/02

(52) U.S. Cl. 283/52

(57) ABSTRACT

a) The method of making these playbooks would depend on the sports league marketing/printing department. I would sell the idea and a sample coupon booklet along with coupon verbiage and their art department (or their outside contractor) would design the perforated coupon booklet (which will be color coordinated with their team colors and logo) and placed out on display at sports, department, and card stores all year long. Once their design template is created, it will be easy for them to produce each year by just changing the year. This is a new gift idea and there are currently no sports playbooks in stores. This new and unique idea is aimed at pleasing the sports enthusiast in a very satisfying way by eliminating stress and tension on game day and so the enthusiast can sit back and enjoy the sporting event.

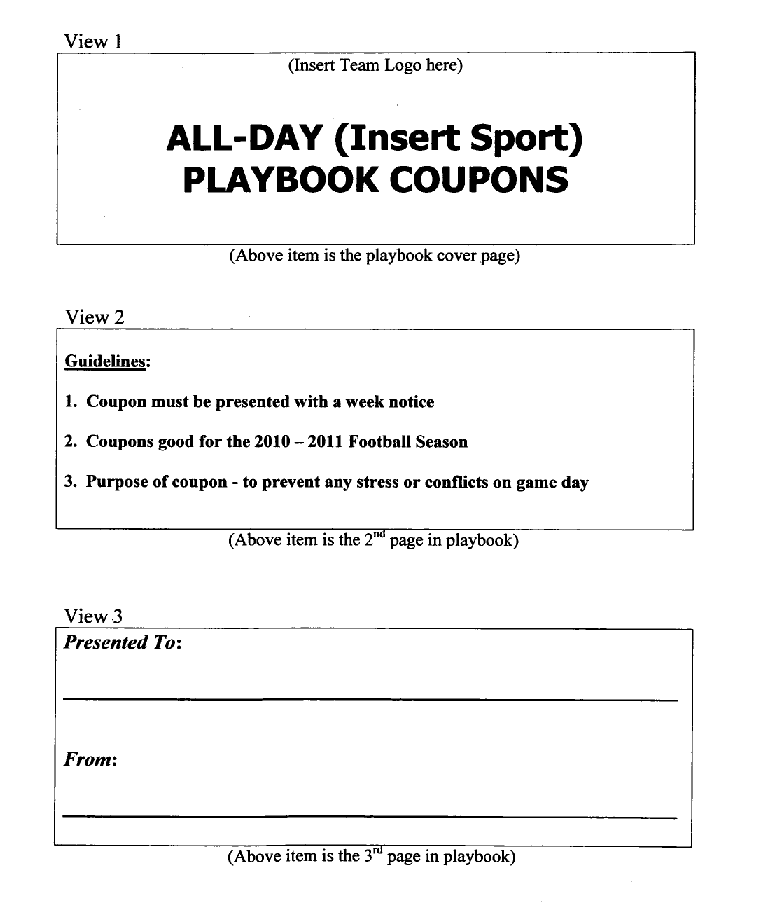

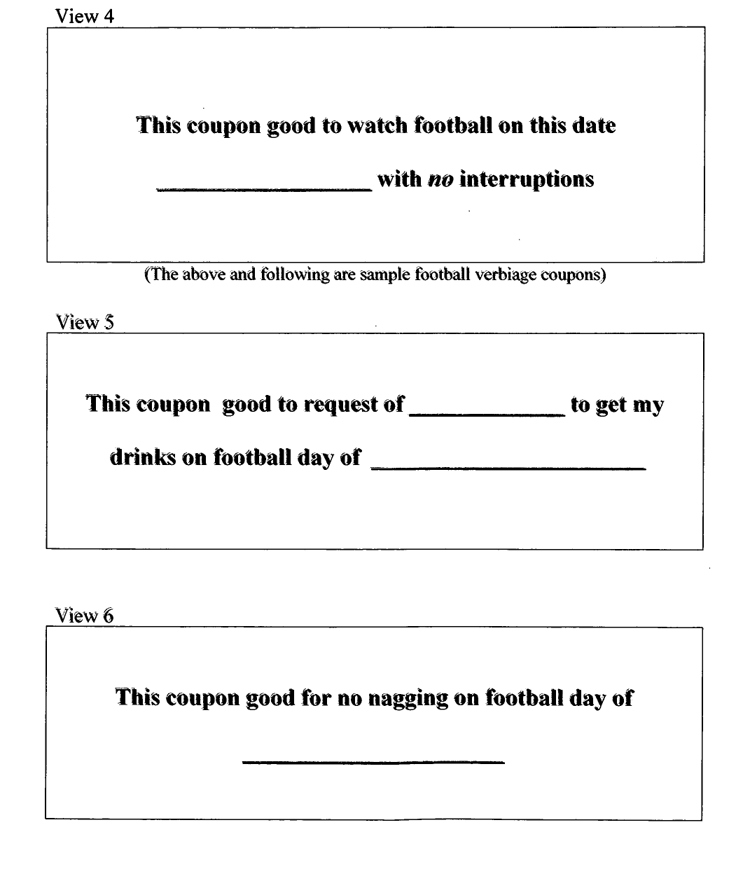

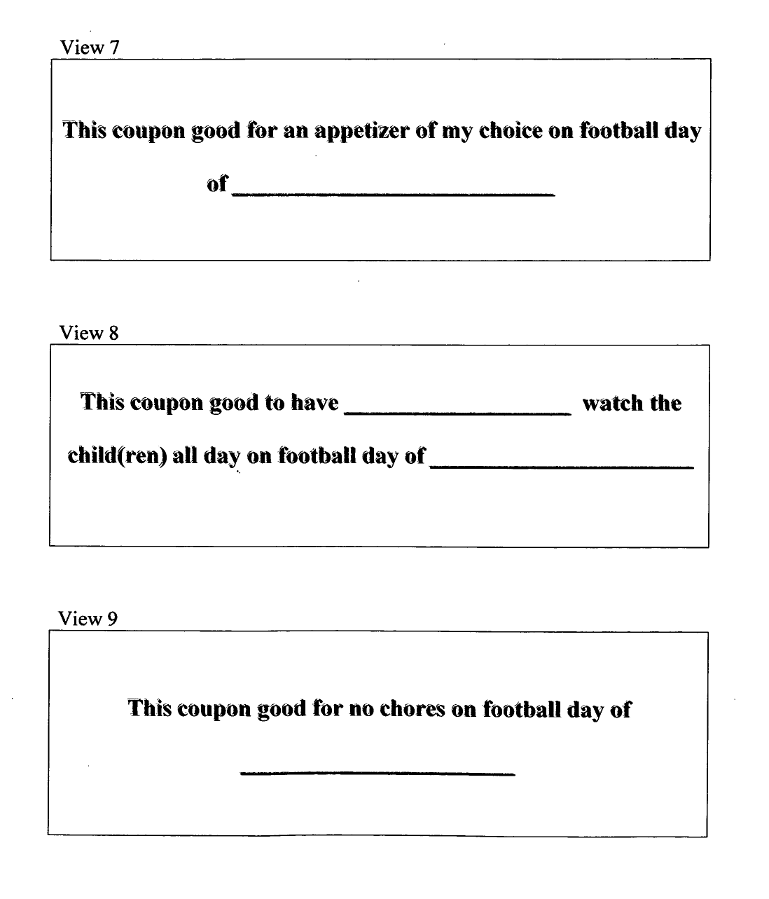

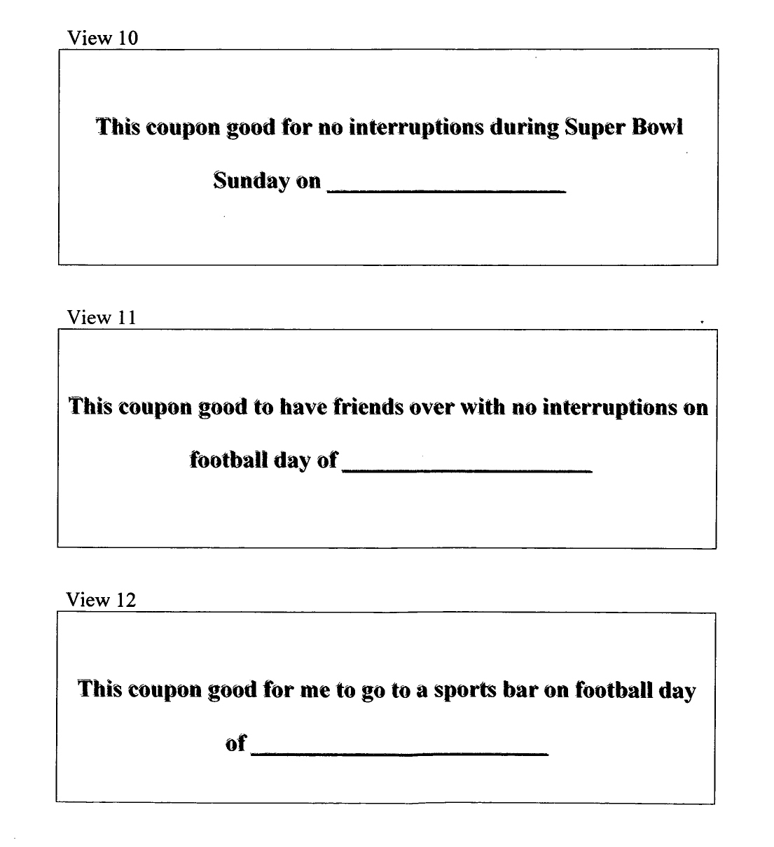

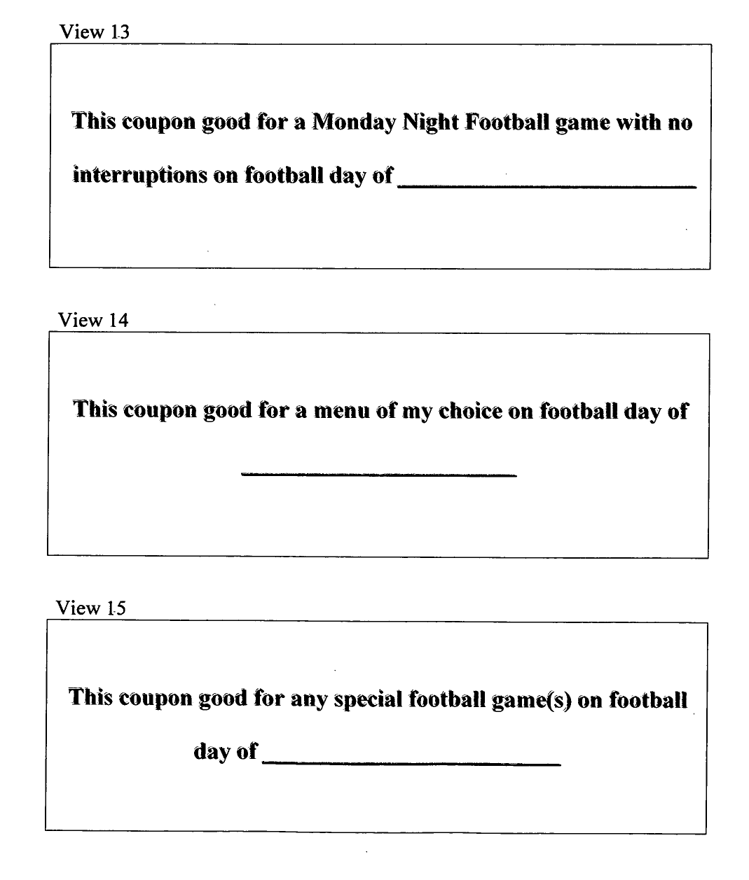

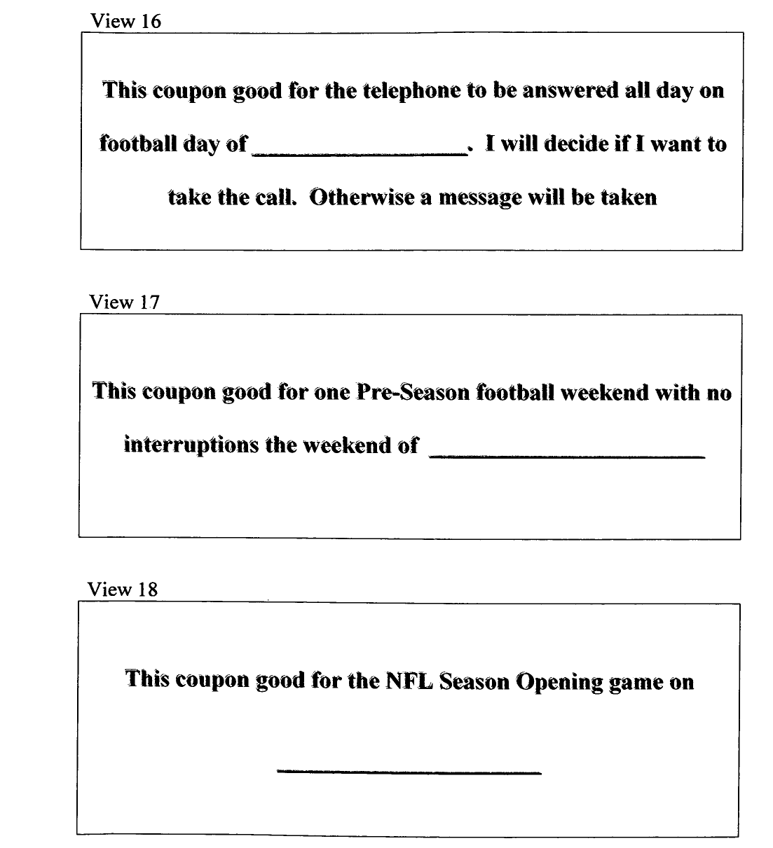

### CROSS-REFERENCE TO RELATED APPLICATIONS

a) Prior Application No.—61/340,406

b) Filing Date—Mar. 17, 2010

### STATEMENT REGARDING FEDERALLY SPONSORED RESEARCH OR DEVELOPMENT

a) N/A

### REFERENCE TO SEQUENCE LISTING, A TABLE, OR A COMPUTER PROGRAM LISTING COMPACT DISC APPENDIX

a) N/A

### BACKGROUND OF THE INVENTION

a) Field of Invention

This invention gears to the sporting field and the avid sports enthusiast

b) References to Specific Documents

This invention is drawn towards wife's and girlfriend's who have avid sports enthusiasts that just need to watch or attend sporting events without feeling the stress and tension of their significant other. Women have a tendency of feeling neglected when their man is all wrapped up with sports. But this invention mentally prepares the woman for the specific sporting day. It will show the sports enthusiast that she really cares for them.

### BRIEF SUMMARY OF THE INVENTION

a) General Idea of Invention—the creation of all-day sports coupon booklet to give to your sports enthusiasts. The object of this invention is to stop the unnecessary tension and conflict between couples on sports day.

### BRIEF DESCRIPTION OF THE SEVERAL VIEWS OF DRAWING

a) View 1—this is the playbook cover page and will contain the team colors and logo on the front. This cover playbook page will be made of durable (thick), shiny gloss paper

b) View 2—this playbook page contains the specific guidelines for the recipient to follow to redeem the coupons. Recipient must give a weeks notice when redeeming the coupon in order for the buyer to make ample arrangements. By giving this weeks notice it will get the buyer in the proper frame of mind knowing what they have committed to. Playbooks are good for the one specific sports season. They can not be used in the next year's season

c) View 3—this playbook page contains the information of who is giving the playbook and the recipient's name

d) Views 4 through 18—these are samples of actual coupon verbiage for a sports season (in this example—football)

e) All of the coupons in the playbook will be perforated so the recipient can easily tear out and use on the specific date that he/she has selected

### DETAILED DESCRIPTION OF THE INVENTION

a) I am not a company but just an individual that came up with this idea and I am not interested in producing these items. I just want to sell the idea to the major league sports leagues and they take it from there. Sports are a BIG factor in everyone's life. Men especially love to attend sport games or watch the games on television. But with raising a family or attending to a wife's, girlfriends, or child's needs it can create tension, stress, and conflict. It is sometimes difficult to come up with a unique gift idea for that special someone in your life, especially now with the difficult economy that many are suffering through. Sometimes just the small sacrifices that someone makes mean more than any expensive gift. I would like to sell my idea of an “All-Day (insert sport) Playbook Coupon” booklet. We've all seen coupon books displayed at various card stores when Valentine's Day is approaching and the traditional “love” coupons. Why not have coupon books for sport's enthusiasts? These coupons would range from enjoying a full day of football with no nagging or interruptions to having an appetizer of your choice made for you during the big game. For example, my son LOVES the football season and would love to enjoy himself on Football Sundays without feeling guilty or causing tension with his wife. But if his wife goes into the football season knowing that she gave her husband these coupons and was well prepared for the specific dates he will be using them, then the likelihood of tension on football day can be eliminated and make a marriage must happier. I will be submitting my idea to all sports leagues (i.e. NFL, NCAA, MLB, NBA, NASCAR, PGA, and the NHL). My objective is to have these coupons at any sports stores and card stores. For example, in the San Francisco area their stores will have the coupon playbooks out on display all year or before football season begins (printed with the 49ers logo and color coordinated with the team colors on the playbook cover.) In addition, what a great stocking stuffer gift!! Each football playbook will have different quantities of 5, 10, or 15, etc. depending on what the buyer wants to give to their recipient. I have asked several sports enthusiasts on what they thought of this idea and they all agreed with me and loved the idea. They want to be able to relax and enjoy their sporting event with no tension and arguments. This inexpensive gift idea will definitely show the sports enthusiast that someone really cares about them. We all know the way to a man's heart is through his stomach and through sports! Sports are the great All-American past time fun so why not help in facilitating the sports day. Wouldn't it be nice if this gift idea could possibly assist in saving marriages?

What is claimed is:

1. My claim as the inventor is I am recognizing that a sports enthusiast should enjoy their sporting day (on television, with friends, or arena) without stress and tension from a significant other by presenting their perforated coupon before game day to the purchaser.

2. My claim as the inventor is the purchaser buys this sports playbook knowing that they are giving the recipient something that is really important to them.

3. My claim as the inventor is the purchaser will have a sense of pride that they are fulfilling the sports enthusiasts needs.

4. My claim as the inventor is the purchaser can buy different size coupon playbooks depending on what they want to give.

5. My claim as the inventor is recognizing that sports are important factor in many households.

6. My claim as the inventor is recognizing the importance of the elimination of the guilt factor for the sports enthusiast.

7. My claim as the inventor is recognizing the importance of peace and harmony in the household.

8. My claim as the inventor is to sell this idea of the playbook coupon booklet to all major sports leagues for the recipient to use at his/her discretion during the specific sports season.

9. My claim is to have these playbooks out on display year round or at the beginning of the specific sports season.

10. My claim is to have this as a great gift giving idea for holidays, birthdays, anniversaries, and stocking stuffers.
